(19) United States
(12) Patent Application Publication
(10) Pub. No.: US 2007/0024709 A1
(43) Pub. Date: Feb. 1, 2007

(54) Control apparatus and method for recording number of person in moving image, and still-image playback apparatus and method

(75) Inventor: Masaru Osada, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/488,828

(22) Filed: Jul. 19, 2006

(30) Foreign Application Priority Data
Jul. 26, 2005 (JP) 2005-215486

(51) Int. Cl. H04N 7/18; H04N 5/225

(52) U.S. Cl. 348/143; 348/169

(57) ABSTRACT

The number of persons that appear in an image constituting a moving image is recorded on a recording medium together with data representing the moving image. Moving-image data is read from the recording medium. Images of persons contained in every third frame of an image among the images constituting the moving image are detected and the number image of persons detected is calculated. The calculated number of persons is stored in a number-of-persons table and the stored table is recorded on the recording medium. The invention can be utilized in finding the beginning of a moving-image segment by using the number-of-persons table.

### BACKGROUND OF THE INVENTION

1. Field of the Invention

This invention relates to a control apparatus and method for recording the number of persons in a moving image, and to an apparatus and method for playing back still images.

2. Description of the Related Art

Owing to the increase in recording capacity of recording media such as memory cards, it is now possible for such recording media to record still-image data representing a larger number of frames of still images. However, there are occasions where it is difficult to find a desired image when a large number of frames of still images have been recorded. For this reason, there are examples of prior art in which a desired still image can be found from among a large number of frames of still images (see the specification of Japanese Patent Application Laid-Open No. 2004-236120).

Further, there is prior art for displaying images of faces as thumbnails in the form of a list and finding an image in which a person of interest appears (see the specification of Japanese Patent Application Laid-Open No. 2003-46911), and prior art for extracting the image of a face and utilizing the extracted face image to group together images that contain the same person (see the specification of Japanese Patent Application Laid-Open No. 2001-167110).

All of these examples, however, merely take note of face images.

### SUMMARY OF THE INVENTION

Accordingly, an object of the present invention is to utilize the number of persons contained in an image.

According to a first aspect of the present invention, the foregoing object is attained by providing a control apparatus for recording the number of persons that appear in a moving image, comprising: a number-of-persons detecting device (means) for detecting the number of persons contained in an image; a detection control device (means) for controlling the number-of-persons detecting device (means) so as to detect, for every specific frame, the number of persons contained in one frame of an image that constitutes a moving image represented by applied moving-image data; and a number-of-persons recording control device (means) for recording data, which represents the number of persons detected by the number-of-persons detecting device (means) under the control of the detection control device (means), on a recording medium in association with the specific frame and the moving-image data.

The first aspect of the present invention also provides a method suited to the above-described control apparatus for recording the number of persons in a moving image. Specifically, the first aspect of the present invention provides a control method for recording the number of persons in a moving image, comprising the steps of: detecting, for every specific frame, the number of persons contained in one frame of an image that constitutes a moving image represented by applied moving-image data; and recording data, which represents the number of persons detected, on a recording medium in association with the specific frame and the moving-image data.

In accordance with the first aspect of the present invention, the number of persons contained in one frame of an image constituting a moving image is detected on a per-specific-frame basis. Data representing the number of persons detected is recorded on a recording medium in association with the specific frame and moving-image data.

In accordance with the first aspect of the present invention, data representing the number of persons contained in a specific frame of an image constituting a moving image is recorded on a recording medium. Accordingly, editing, a change in playback method, etc., utilizing the number of persons can be implemented.

The apparatus may further comprise an image sensing device (means) for sensing the image of a subject at a fixed period and outputting moving-image data representing a moving image of the image of the subject. In this case, the detection control device (means) would control the number-of-persons detecting device so as to detect, for every specific frame, the number of persons contained in one frame of an image that constitutes a moving image represented by the moving-image data that is output from the image sensing device (means).

The moving-image data is recorded on the recording medium, and the apparatus may further comprise a reading device for reading the moving-image data from the recording medium. In this case, the detection control device (means) would control the number-of-persons detecting device so as to detect, for every specific frame, the number of persons contained in one frame of an image that constitutes a moving image represented by the moving-image data that has been read by the reading device (means).

The apparatus may further comprise a moving-image playback device (means) for playing back the moving-image data; a display control device (means) for controlling a display unit so as to display the moving image represented by the moving-image data played back by the moving-image playback device (means); and a moving-image playback control device (means) for controlling the moving-image playback device so as to start playback of the moving-image data from a starting position decided based upon the number of persons represented by data representing the number of persons recorded by the number-of-persons recording control device. This makes it possible to start playback of a moving image from a segment having the desired number of persons.

The apparatus may further comprise a moving-image playback device for playing back the moving-image data; a display control device (means) for controlling a display unit so as to display the moving image represented by the moving-image data played back by the moving-image playback device (means); and a playback control device (means) for controlling the moving-image playback device so as to change playback speed in the moving-image playback device (means) based upon the number of persons represented by data representing the number of persons recorded by the number-of-persons recording control device (means). This makes it possible to change playback speed based upon the number of persons.

The apparatus may further provide a moving-image file generating device (means) for generating a plurality of moving-image files from applied moving-image data based upon the number of persons detected by the number-of-persons detecting device (means) under the control of the detection control device (means); and a moving-image file recording control device for recording the plurality of moving-image files, which have been generated by the moving-image file generating device (means), on the recording medium.

Moving-image files that differ for every number of persons can be generated. This makes it possible to erase a file indicative of a moving image in which a prescribed number of persons appear.

According to a second aspect of the present invention, the foregoing object is attained by providing a still-image playback apparatus comprising: a still-image reading device (means) for reading still-image data from a recording medium on which a plurality of frames of still-image data representing a still image have been recorded; a number-of-persons detecting device (means) for detecting the number of persons contained in a still image represented by still-image data that has been read by the still-image reading device (means); a determination device (means) for determining whether to display the still image, which is represented by the still-image data that has been read, based upon the number of persons detected by the number-of-persons detecting device (means); a display control device (means) for controlling a display unit so as to display the still image that the determination device (means) has determined is to be displayed; and a playback control device (means) for controlling the still-image reading device (means), the number-of-persons detecting device (means), the determination device (means) and the display control device (means) so as to repeat processing for reading the still-image data, processing for detecting number of persons, determination processing and processing for controlling the display unit.

The second aspect of the present invention also provides a method suited to the above-described still-image playback apparatus. Specifically, the first aspect of the present invention provides a still-image playback method comprising the steps of: reading still-image data from a recording medium on which a plurality of frames of still-image data representing a still image have been recorded; detecting the number of persons contained in a still image represented by still-image data that has been read; determining whether to display the still image, which is represented by the still-image data that has been read, based upon the number of persons detected; displaying on a display unit the still image determined is to be displayed; and repeating processing for reading the still-image data, processing for detecting number of persons, determination processing and processing for controlling the display unit.

In accordance with the second aspect of the present invention, still-image data that has been recorded on a recording medium is read and the number of persons contained in the still image represented by the read still image data is detected. Whether or not the still image is to be displayed is determined based upon the number of persons detected. If it is determined that the still image is to be displayed, then the still image is displayed. This processing is repeated. Whether a still image is to be displayed or not displayed can be decided in accordance with the number of persons.

For example, the display control device (means) controls the display unit in such a manner that length of display time differs based upon the number of persons detected by the number-of-persons detecting device (means). This makes it possible to change length of display time in accordance with the number of persons.

The apparatus may further comprise a single-erase command input device (means) for inputting a command to erase a still image displayed under the control of the display control device (means); an erase-command-data add-on device (means) for adding on data, which indicates the erase command that has been input from the single-erase command input device (means), to still-image data representing a still image that was being displayed on the display unit when the command was input from the single-erase command input device (means); a batch-erase command input device (means); and an erasing device (means) for erasing the still-image data, to which the erase-command data has been added on, from the recording medium in response to input of a batch-erase command from the batch-erase command input device (means). This makes possible the batch erasure of still images containing a desired number of persons.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of a digital still camera;

FIG. 2 is a flowchart illustrating processing for recording a number-of-persons table on a recording medium;

FIG. 3 illustrates an example of a number-of-persons table;

FIG. 4 illustrates an example of a disk structure;

FIG. 5 illustrates an example of the structure of a moving-image file;

FIG. 6 illustrates an example of a video-tape recording format;

FIG. 7 illustrates the structure of a track;

FIGS. 8 and 9 are flowcharts illustrating playback processing;

FIG. 10 is a flowchart illustrating processing for recording a number-of-persons table on a recording medium when moving-image data is recorded;

FIG. 11 is a flowchart illustrating slideshow processing; and

FIGS. 12 and 13 are flowcharts illustrating processing for performing batch erasure.

### DESCRIPTION OF THE PREFERRED EMBODIMENT

A preferred embodiment of the present invention will now be described in detail with reference to the drawings.

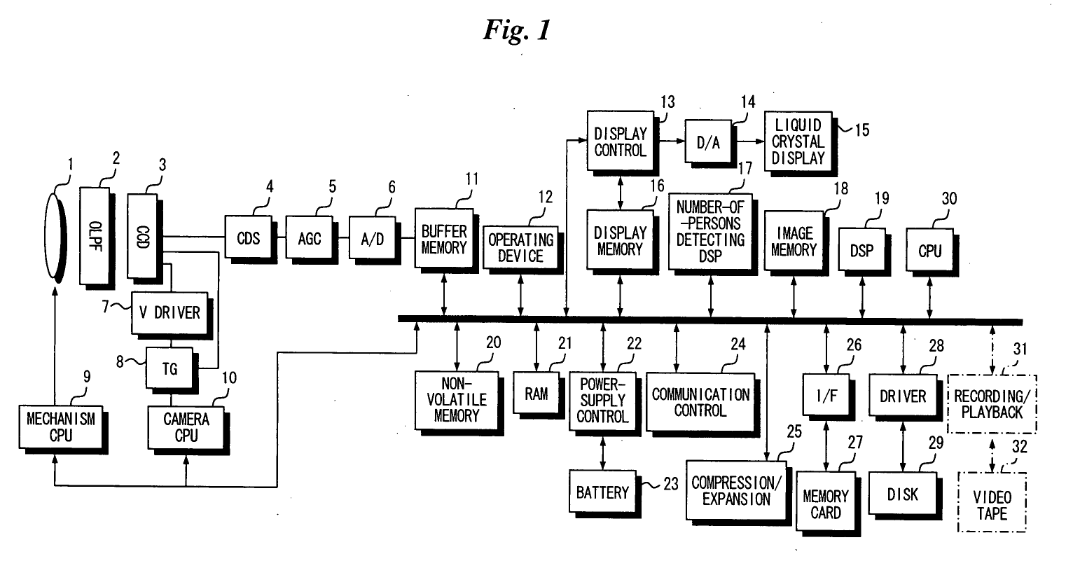

FIG. 1 is a block diagram illustrating the electrical structure of a digital movie/still camera embodying the present invention.

The digital movie/still camera according to this embodiment is capable of recording moving images and still images and of playing back these images. In particular, in this embodiment, specific frames from among frames constituting a moving image and data representing the number of images of persons contained in each still image can be recorded in a moving-image file representing the moving image and still-image file representing the still image, respectively. Various uses become possible by using the data representing the number of persons. For example, if an image is a moving image, it is possible to locate the beginning of a segment in which a desired number of persons appears, change the speed of fast-forward/reverse and partition a file that is based upon the number of persons. If an image is a still image, it is possible to change the length of display time of each still image that constitutes a slide show composed of still images, as well as the order in which the still images are displayed.

Operation of the overall digital still camera is controlled by a CPU 30.

The digital still camera is provided with an operating device 12 from which operating signals are output and applied to the digital still camera. The operating device 12 includes a mode switch for setting various modes, a shutter-release button for recording still images, and a movie recording switch for recording a moving picture. Various modes such as a still-image recording mode, movie recording mode, still-image playback mode, movie playback mode and number-of-persons detecting mode can be set by the mode switch.

The digital still camera is further provided with a non-volatile memory 20 for storing programs and other data, a RAM 21 for storing data temporarily, a communication control circuit 24 for communicating with other devices, and a power-supply control circuit 22 for supplying each circuit with power supplied from a battery 23.

An imaging lens 1 and an optical low-pass filter 2 are provided in front of a CCD 3. The imaging lens 1 is positioned by a mechanism CPU 9. The image of a subject is formed on the photoreceptor surface of the CCD 3 by the imaging lens 1 and optical low-pass filter 2. Horizontal transfer pulses that are output from a timing generator 8 controlled by a camera CPU 10 are applied to the CCD 3. Vertical transfer pulses that are output from a V driver 7 are also applied to the CCD 3. A video signal output from the CCD 3 is controlled based upon these horizontal and vertical transfer pulses.

If the still-image recording mode or movie recording mode is set by the mode switch, the image of the subject is sensed at a fixed period by the CCD 3 and a video signal representing the image of the subject is output at a fixed period. The video signal output from the CCD 3 undergoes correlated double sampling in a CDS (correlated double sampling) circuit 4. The video signal output from the CDS circuit 4 is subjected to a white balance correction in an AGC (automatic gain control) circuit 5. The video signal output from the AGC circuit 5 is converted to digital image data in an analog/digital converting circuit 6.

The digital image data is applied to a DSP (digital signal processing) circuit 19 via a buffer memory 11. The DSP circuit 19 subjects the digital image data to prescribed digital signal processing such as a gamma correction. The image data output from the DSP circuit 19 is applied to a digital/analog converting circuit 14 via a display memory 16 and display control circuit 13. The digital/analog converting circuit 14 restores the digital image data to an analog video signal and applies the analog video signal to a liquid crystal display device 15. The image of the subject sensed at the fixed period is displayed as a moving image on the display screen of the liquid crystal display device 15.

If the shutter-release button is pressed in a case where the still-image recording mode has been set, the image data (still-image data) that has been output from the analog/digital, converting circuit 6 in the manner described above is applied to a buffer memory 11, where the data is stored temporarily. The still-image data is read from the buffer memory 11 and applied to a compressing/expanding circuit 25, which subjects the data to data compression. The still-image data that has been compressed is applied to a memory card 27 via an interface 26, whereby the data is recorded on the memory card 27. If the number-of-persons recording mode has been set, the still-image data that has been output from the buffer memory 11 is applied to a number-of-persons detecting DSP (digital signal processing circuit) 17, which proceeds to detect the number of images of persons contained in the still image represented by the input still-image data. Data representing the number of persons is recorded on the memory card 27 together with the still-image data compressed in the manner described above.

If the movie recording switch is pressed in a case where the movie recording mode has been set, image data (moving-image data) that is output from the analog/digital converting circuit 6 at the fixed period while the movie recording switch is being pressed is applied to a driver 28 sequentially. The moving-image data is recorded on a disk 29 by the driver 28. If the number-of-persons recording mode has been set, image data representing the image of every third frame (it goes without saying that the image need not be of every third frame) is stored in the buffer memory 11 sequentially from among the still images that constitute the moving image represented by the moving-image data that has been output from the analog/digital converting circuit 6. The image data that has been recorded in the buffer memory 11 is read out in order and applied to the number-of-persons detecting DSP 17. The number-of-persons detecting DSP 17 detects the number of images of persons contained in each image. Data representing the number of persons detected is applied to the driver 28 and is recorded on the disk 29 together with the moving-image data.

If the still-image playback mode is set by the mode switch, still-image data that has been recorded on the memory card 27 is read. The read still-image data is expanded in the compressing/expanding circuit 25 via the interface 26. The expanded still-image data is applied to the digital/analog converting circuit 14 via the display memory 16 and display control circuit 13. A video signal obtained by conversion in the digital/analog converting circuit 14 is applied to the liquid crystal display device 15, whereby a still image is displayed.

If the movie playback mode is set by the mode switch, moving-image data that has been recorded on the disk 29 is read by the driver 28. The read image data is applied to the digital/analog converting circuit 14 via the display memory 16 and display control circuit 13. The moving-image data is converted to a video signal in the digital/analog converting circuit 14. The video signal is applied to the liquid crystal display device 15, whereby a movie is displayed.

In the embodiment set forth above, the moving-image data is recorded on the disk 29 and moving-image data that has been recorded on the disk 29 is read for playback. However, a recording/playback control circuit 31 may be provided for recording the moving-image data on a video tape 32 and reading moving-image data that has been recorded on the video tape 32. Thus, recording of moving-image data on the video tape 32 and playback of moving-image data that has been recorded on the video tape 32 can be performed. It may also be so arranged that the moving-image data is recorded on the memory card 27.

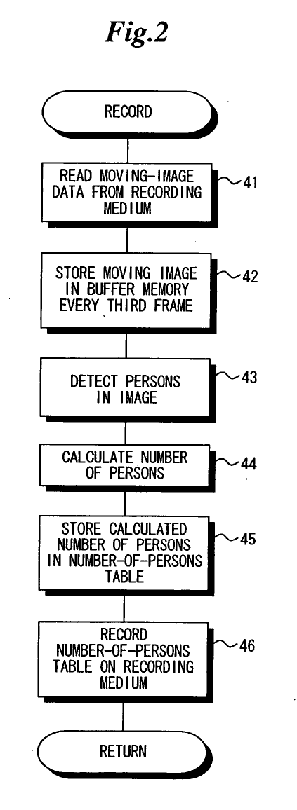

FIG. 2 is a flowchart illustrating processing in a case where the number-of-persons recording mode has been set.

First, moving-image data is read from the recording medium (e.g., the disk 29) (step 41). The moving-image data would be read from the disk 29 or video tape 32. If the moving-image data has been recorded on the memory card 27, however, it would be read from the memory card 27. From among the images of the multiplicity of frames that constitute the moving image represented by the moving-image data in the moving-image data that has been read, image data representing the image of every third frame is sequentially applied to and stored temporarily in the buffer memory 11 (step 42). Images of persons in each of the images of every third frame are detected (step 43) and the number of persons detected is calculated (step 44).

The number of persons thus calculated is stored in a number-of-persons table in correspondence with the frame of the image (step 45). The number-of-persons table is recorded on the recording medium on which the moving-image data has been recorded (step 46).

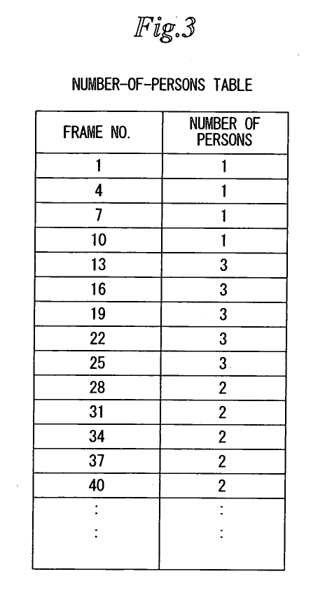

FIG. 3 illustrates the number-of-persons table.

The number-of-persons table consists of frame numbers and numbers of persons contained in person images that are included in the images specified by these frame numbers. Since person images are detected from images of every third frame among the images of the multiplicity of frames that constitute the moving image, as described above, the frame numbers are the numbers of every third frame. Images of persons are detected in the image specified by each frame number and the number of these person images is calculated. The number of persons thus calculated is stored in the number-of-persons table in correspondence with the frame number. For example, images of frame numbers 1 to 10 each contain one person, images of frame numbers 13 to 25 each contain three persons, and images of frame numbers 28 to 40 each contain two persons.

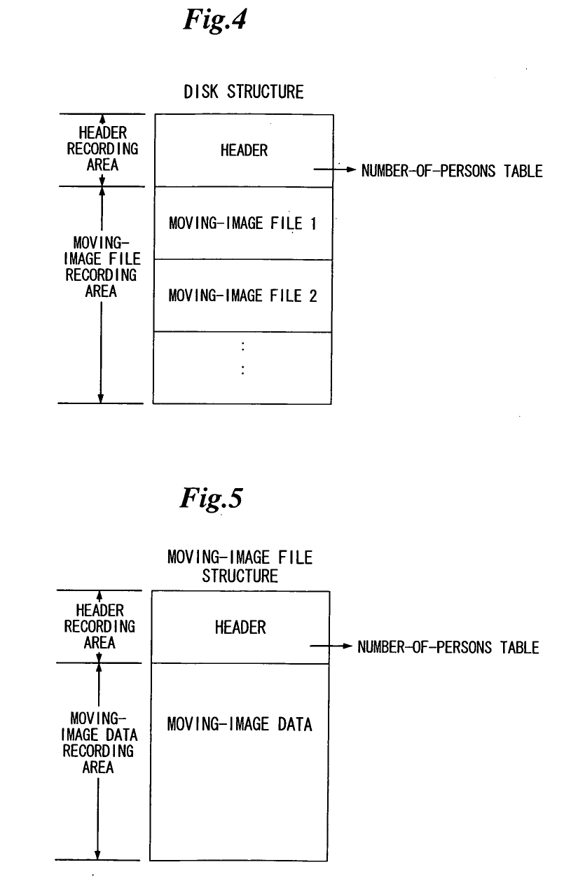

FIG. 4 illustrates the data structure of the disk 29.

The disk 29 includes a header recording area and a moving-image file recording area. The header recording area records data for managing the disk 29. Moving-image files containing moving-image data representing moving images have been recorded in the moving-image file recording area. For every moving-image file that has been recorded in the moving-image file recording area, the above-described number-of-persons table is recorded in the header recording area.

Thus it may be so arranged that a number-of-persons table is recorded in the header recording area of the disk with regard to respective ones of all moving-image files that have been recorded on the disk 29.

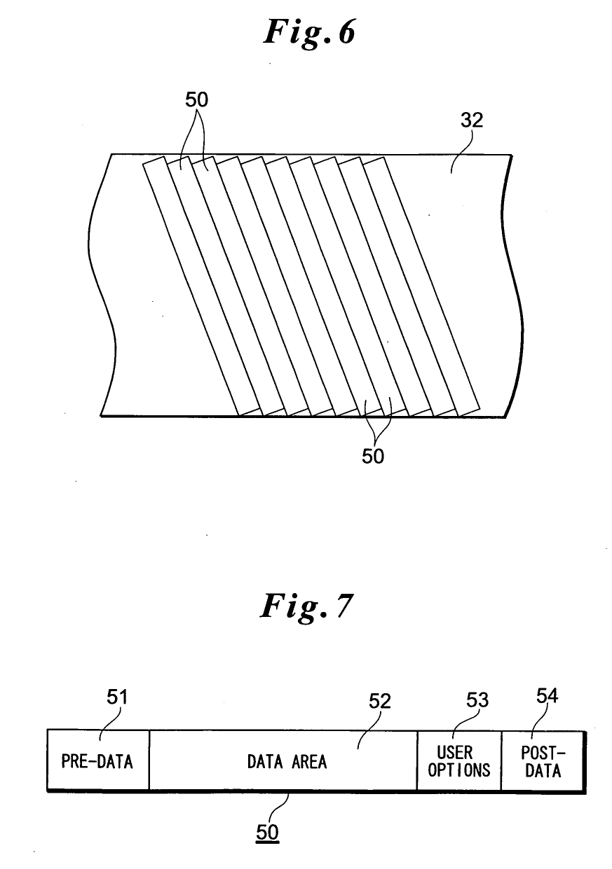

FIG. 5 illustrates an example of the file structure (data structure) of a moving-image file recorded on the disk 29.

The moving-image file includes a header recording area and a moving-image data recording area. Moving-image data is recorded in the moving-image data recording area, and data for managing the moving-image file is recorded in the header recording area. A number-of-persons table regarding the moving image represented by the moving-image data that has been recorded in the moving-image data recording area also is recorded in the header recording area.

Thus it may be so arranged that for every moving-image file, a number-of-persons table corresponding to the moving-image file is recorded.

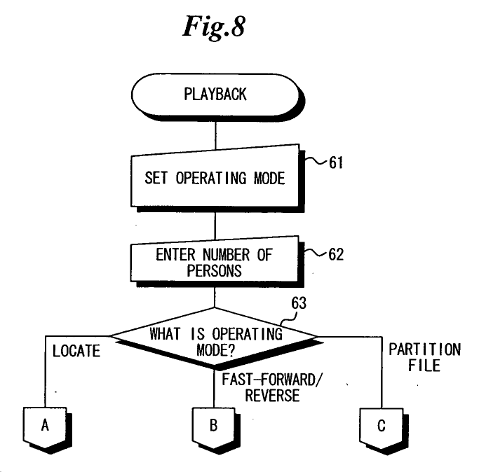

FIG. 6 illustrates an example of the recording format of a video tape.

A number of tracks 50 are defined on a video tape 32 along the longitudinal direction thereof at a somewhat oblique angle with respect to the vertical. For example, image data representing one frame of an image is recorded using ten tracks.

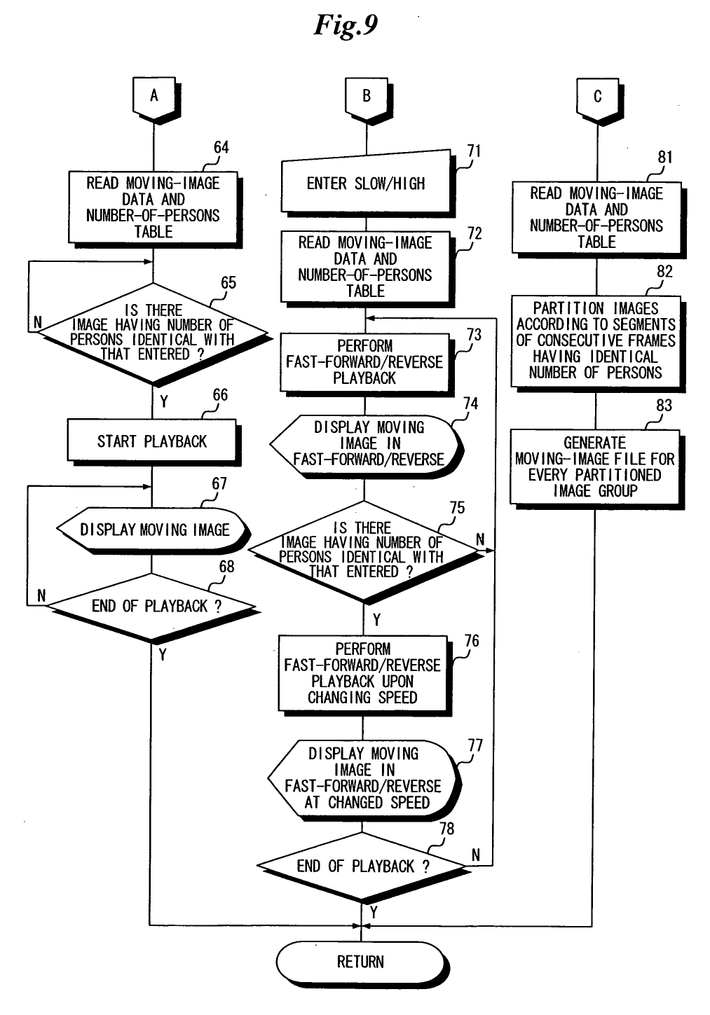

FIG. 7 illustrates the structure of one track 50.

A pre-data area 51, a data area 52, a user option area 53 and a post-data area 54 are defined on the track 50. Predetermined data is recorded in the pre-data area 51 and post-data area 54, and image data is recorded in the data area 52. The user option area 53 is an area that can be used by the user. The above-described number-of-persons table is recorded in the user option area 53.

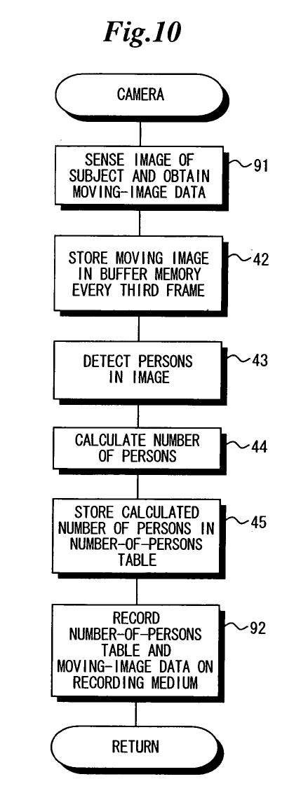

FIGS. 8 and 9 are flowcharts illustrating processing for implementing the movie playback mode.

The playback mode is such that operation can be changed using the number of persons known from the number-of-persons table recorded on the recording medium.

First, the operating mode is set by the user (step 61). Operating modes include a locate mode for reproducing a moving image from a specific segment; a fast-forward/reverse mode for reproducing a moving image in fast-forward/reverse, and a file partitioning mode for partitioning a moving-image file. Since the file partitioning mode necessitates that a moving-image file be recorded on the recording medium, this mode cannot be selected in playback in a case where moving-image data has been recorded on video tape.

Next, the number of persons for which operation is to be changed is input by the user employing the operating device 12 (step 62). The operating mode that has been set by the user is then checked (step 63).

If the locate mode has been set, the moving-image file (moving-image data) and the number-of-persons table are read from the recording medium (e.g., the disk 29) (step 64). Reference is had to the number-of-persons table to find the frame number of the initial image from among images containing a number of persons identical with that input by the user (step 65). Playback of the moving-image data starts from the image having the frame number found (step 66) and the moving image starts being displayed (step 67). Display of the moving image continues until the end (step 68).

If the fast-forward/reverse mode has been set, the user employs the operating device 12 to enter whether playback is to be performed at a speed (slow speed) slower than normal or at a speed (high speed) faster than normal with regard to the segment of the image having the number of persons entered by the user (step 71). The moving-image file (moving-image data) and number-of-persons table are read from the recording medium (step 72).

The moving image represented by the read moving-image data is played back in fast-forward or reverse (rewind) at a prescribed speed (or at a speed that has been specified by the user) (step 73) and the moving image is displayed in fast-forward or reverse (step 74). If a segment of the moving image that contains the number of persons entered by the user is reached (“YES” at step 75), fast-forward or reverse playback is performed upon changing the speed to that in accordance with the slow-or high setting that was entered by the user (step 76). The moving image is displayed in fast-forward or reverse playback at the changed speed (step 77). If a segment of the moving image that contains a number of persons different from that entered by the user is reached, then playback is performed in fast-forward or reverse again at a prescribed speed.

Fast-forward or reverse playback in which the speed changes in accordance with the number of persons is carried out until playback ends (step 78).

If the file partitioning mode has been set, the moving-image file (moving-image data) and the number-of-persons table are read from the recording medium (step 81). The images are partitioned in such a manner that from among the multiplicity of images that constitute the moving image, images that run consecutively and have the same number of images of persons are formed into a group (step 82). A new moving-image file is generated for every group of images obtained by partitioning (step 83). For instance, in terms of the example shown in FIG. 3, the number of persons appearing consecutively is one in the images of frame numbers 1 to 10 and therefore one moving-image file is generated from these images; the number of persons appearing consecutively is three in the images of frame numbers 13 to 25 and therefore one moving-image file is generated from these images; and the number of persons appearing consecutively is two in the images of frame numbers 28 to 40 and therefore one moving-image file is generated from these images.

Although the number of persons contained in an image is known every third frame from the number-of-persons table, the number of persons in images of frames between every third frame is not known. Accordingly, with regard to images that prevail during a change in number of persons, these images may be placed in the group prevailing prior to the change in number of persons or in the group prevailing after the change in number of persons. For example, in the case shown in FIG. 3, the number of persons is one with regard to the image of frame number 10 and the number is three with regard to the image of frame number 13. However, the number of persons with regard to frame numbers 11 and 12 between frame numbers 10 and 13 is not known. Accordingly, with regard to frame numbers 11 and 12, these images may be placed in the group of images of frame numbers 1 to 10 or in the group of images of frame numbers 13 to 25. Further, the image of frame number 11 may be placed in the group of images of frame numbers 1 to 10, and the image of frame number 12 may be placed in the group of images of frame numbers 13 to 25.

Further, it may be so arranged that in a case where the number of frames of images that constitute a moving-image file to be newly generated is small, the moving-image file is not generated; a moving-image file being generated anew only in a case where the moving image has a number of frames equal to or greater than a prescribed number.

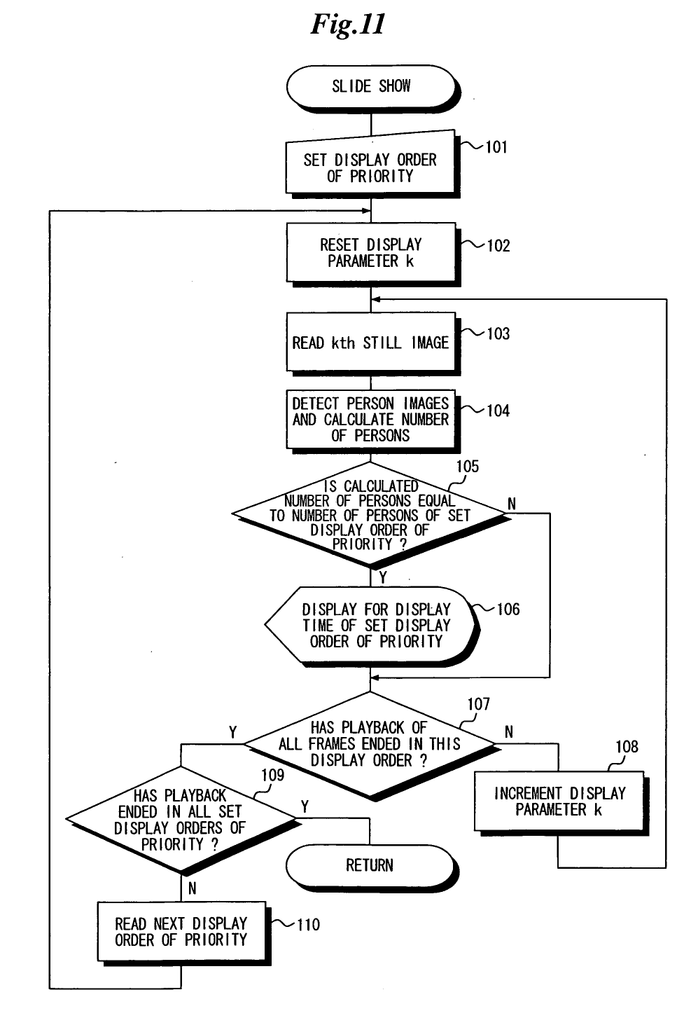

FIG. 10 is a flowchart illustrating recording processing in the movie recording mode. This processing store a number-of-persons table on a recording medium when moving-image data obtained by image sensing is recorded on the recording medium. Processing in FIG. 10 that is identical with that shown in FIG. 2 is denoted by like step numbers and need not be described again.

The image of a subject is sensed and moving-image data representing the image of the subject is obtained (step 91). In a manner similar to that described above, image data representing every third image is stored in the buffer memory 11 (step 42), images of persons in each of these images are detected (step 43) and the number of persons is calculated (step 44). The number of persons calculated is stored in a number-of-persons table in correspondence with the frame number (step 45). The number-of-persons table obtained and the moving-image data (moving-image file) are recorded on the recording medium (step 92).

It is possible to change not only the manner in which movie playback, etc., is performed in accordance with the number of persons but also the manner in which still-image playback, etc., is performed in accordance with the number of persons.

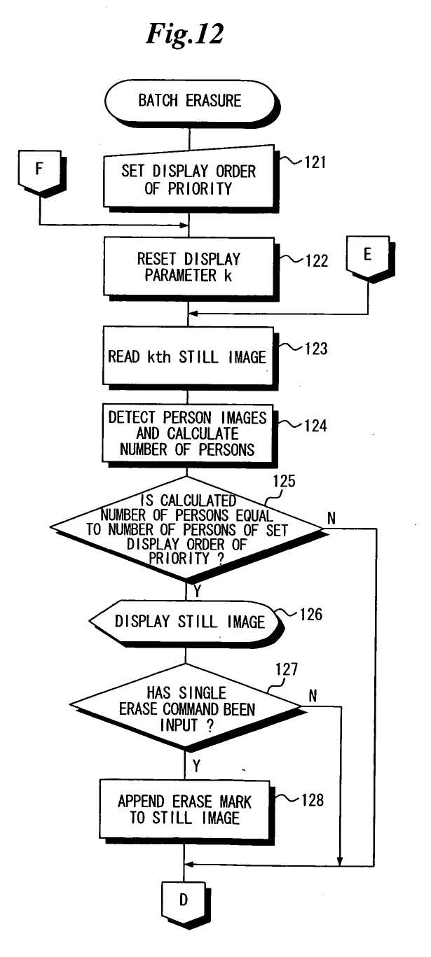

FIG. 11 is a flowchart illustrating slideshow processing. In this slideshow, the display time of a still image that contains a set number of persons is made different from the display times of other still images.

A display order of priority is set by the user (step 101). This involves setting a number of persons for which length of display time is to be changed, as well as the length of display time. A plurality of settings of display order of priority are made. A display parameter k is reset (step 102) and still-image data representing a kth frame of a still image is read from the recording medium (e.g., the memory card 27) (step 103). The images of persons contained in the still image represented by the read still-image data are detected and the number of persons is calculated (step 104). If the calculated number of persons is the number of persons of the set display order of priority (“YES” at step 105), then this still image is displayed for the display time of the set display order of priority (step 106). If the calculated number of persons is not the number of persons of the set display order of priority (“NO” at step 105), then the processing of step 106 is not executed. Accordingly, no display of this still image is presented. If playback of still images in accordance with the initial display order of priority has not ended (“NO” at step 107), the display parameter k is incremented (step 108). The processing of steps 103 to 107 is then repeated.

If playback of still images in accordance with the initial display order of priority has ended (“YES” at step 107), then it is determined whether the playback of still images in accordance with all set display orders of priority has ended (step 109). If playback of still images in accordance with all set display orders of priority has not ended (“NO” at step 109), then the next display order of priority that has been set is read (step 110). The processing of steps 102 to 109 is repeated in accordance with the display order of priority that has been read.

If playback of still images in accordance with all set display orders of priority has ended (“YES” at step 109), then slideshow processing ends.

Thus, it can be so arranged that images having a set number of persons will be displayed first for a prescribed period of time. Further, in the embodiment described above, the number of persons contained in a still image is calculated whenever still-image data is read. However, by generating the above-described number-of-persons table in advance with regard to still images that have been recorded on the recording medium, it is possible to check the number of persons that corresponds to read still-image data using this number-of-persons table.

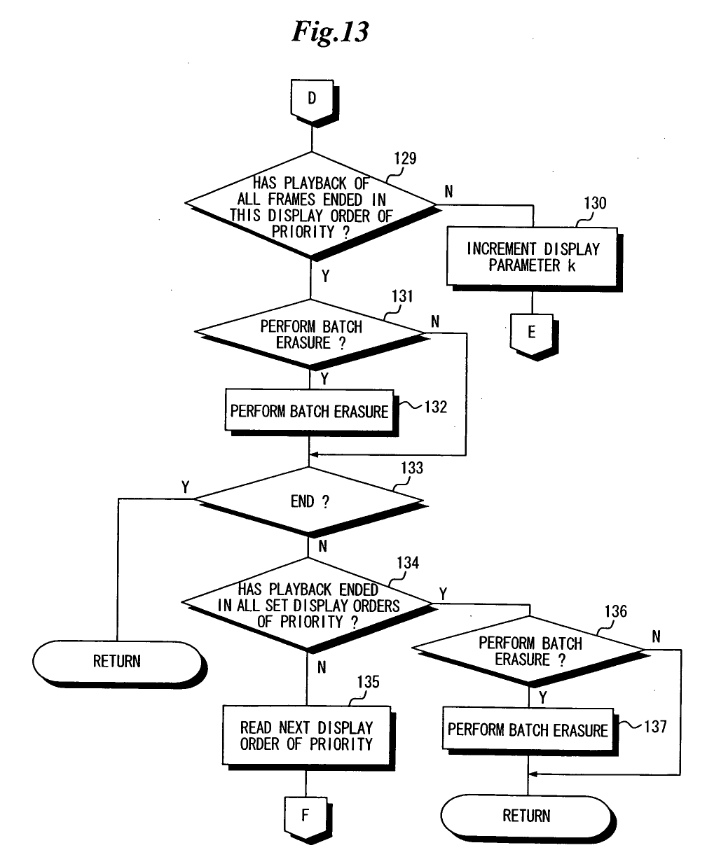

FIGS. 12 and 13 are flowcharts illustrating other processing. These flowcharts show processing for erasing still-image data in one batch.

A display order of priority is set and images are displayed sequentially in accordance with the set order in batch erasure as well. In a case where a displayed still image is erased, a single erase command is applied and an erase mark is appended to the still-image data representing this still image. By subsequently applying a batch command, all still-image data to which the erase mark has been appended is erased.

A display order of priority is set by the user (step 121) and the display parameter k is reset (step 122). Still-image data representing a kth frame of a still image is read from the recording medium (step 123), the images of persons are detected and the number of persons is calculated (step 124). If the calculated number of persons is the number of persons of the display order of priority that has been set (“YES” at step 125), then the still image represented by the read still-image data is displayed (step 126). Upon observing the still image displayed, the user determines whether the still-image data representing this still image is to be erased from the recording medium. In case of erasure, the single erase command is input from the operating device 12 (step 127) and the erase mark is appended to the still-image data (step 128). If the single erase command is not input (“NO” at step 127), the processing of step 128 is skipped. If the number of persons detected from the still image is not the number of persons of the set display order of priority (“NO” at step 125), then the processing of steps 126 to 128 is skipped. Accordingly, no display of this still image is presented.

If playback of all frames has not ended in the set display order of priority (“NO” at step 129), the display parameter k is incremented (step 130). The processing of steps 123 to 128 is then repeated.

If playback of all frames has ended in the set display order of priority (“YES” at step 129), then it is determined whether still-image data to which the erase mark has been appended is to be batch-erased in the still images that have been displayed in this display order of priority (step 131). In case of batch erasure, the still-image data to which the erase mark has been appended is erased from the recording medium in one batch (step 132). If batch erasure is not to be performed at this time (“NO” at step 131), then the processing of step 132 is skipped.

In a case where batch erasure is to continue (“NO” at step 133), it is determined whether playback has ended in all set display orders of priority (step 134). If playback has not ended (“NO” at step 134), then the next display order of priority is read (step 135) and the processing of steps 122 to 133 is repeated. If playback has ended in all set display orders of priority (“YES” at step 134), then whether batch erasure is to be performed is checked again (step 136). If the batch erase command is applied (“YES” at step 136), then all still-image data to which the erase mark has been appended is erased from the recording medium (step 137). If the batch erase command is not applied (“NO” at step 136), then the processing of step 137 is skipped.

Thus, if the residual storage capacity of the recording medium is small, unwanted still images can be erased based upon number of persons.

As many apparently widely different embodiments of the present invention can be made without departing from the spirit and scope thereof, it is to be understood that the invention is not limited to the specific embodiments thereof except as defined in the appended claims.

What is claimed is:

1. A control apparatus for recording the number of persons that appear in a moving image, comprising:
a number-of-persons detecting device for detecting the number of persons contained in an image;
a detection control device for controlling said number-of-persons detecting device so as to detect, for every specific frame, the number of persons contained in one frame of an image that constitutes a moving image represented by applied moving-image data; and
a number-of-persons recording control device for recording data, which represents the number of persons detected by said number-of-persons detecting device under the control of said detection control device, on a recording medium in association with the specific frame and the moving-image data.

2. The apparatus according to claim 1, further comprising an image sensing device for sensing the image of a subject at a fixed period and outputting moving-image data representing a moving image of the image of the subject;
wherein said detection control device controls said number-of-persons detecting device so as to detect, for every specific frame, the number of persons contained in one frame of an image that constitutes a moving image represented by the moving-image data that is output from said image sensing device.

3. The apparatus according to claim 1, wherein the moving-image data is recorded on the recording medium, and said apparatus further comprises a reading device for reading the moving-image data from the recording medium;
said detection control device controlling said number-of-persons detecting device so as to detect, for every specific frame, the number of persons contained in one frame of an image that constitutes a moving image represented by the moving-image data that has been read by said reading device.

4. The apparatus according to claim 1, further comprising:
a moving-image playback device for playing back the moving-image data;
a display control device for controlling a display unit so as to display the moving image represented by the moving-image data played back by said moving-image playback device; and
a moving-image playback control device for controlling said moving-image playback device so as to start playback of the moving-image data from a starting position decided based upon the number of persons represented by data representing the number of persons recorded by said number-of-persons recording control device.

5. The apparatus according to claim 1, further comprising:
a moving-image playback device for playing back the moving-image data;
a display control device for controlling a display unit so as to display the moving image represented by the moving-image data played back by said moving-image playback device; and
a playback control device for controlling said moving-image playback device so as to change playback speed in said moving-image playback device based upon the number of persons represented by data representing the number of persons recorded by said number-of-persons recording control device.

6. The apparatus according to claim 1, further comprising:
a moving-image file generating device for generating a plurality of moving-image files from applied moving-image data based upon the number of persons detected by said number-of-persons detecting device under the control of said detection control device; and
a moving-image file recording control device for recording the plurality of moving-image files, which have been generated by said moving-image file generating device, on the recording medium.

7. A still-image playback apparatus comprising:
a still-image reading device for reading still-image data from a recording medium on which a plurality of frames of still-image data representing a still image have been recorded;
a number-of-persons detecting device for detecting the number of persons contained in a still image represented by still-image data that has been read by said still-image reading device;
a determination device for determining whether to display the still image, which is represented by the still-image data that has been read, based upon the number of persons detected by said number-of-persons detecting device;
a display control device for controlling a display unit so as to display the still image that said determination device has determined is to be displayed; and
a playback control device for controlling said still-image reading device, said number-of-persons detecting device, said determination device and said display control device so as to repeat processing for reading the still-image data, processing for detecting number of persons, determination processing and processing for controlling the display unit.

8. The apparatus according to claim 7, wherein said display control device controls the display unit in such a manner that length of display time differs based upon the number of persons detected by said number-of-persons detecting device.

9. The apparatus according to claim 7, further comprising:
a single-erase command input device for inputting a command to erase a still image displayed under the control of said display control device;
an erase-command-data add-on device for adding on data, which indicates the erase command that has been input from said single-erase command input device, to still-image data representing a still image that was being displayed on the display unit when the command was input from said single-erase command input device;
a batch-erase command input device; and
an erasing device for erasing the still-image data, to which the erase-command data has been added on, from the recording medium in response to input of a batch-erase command from said batch-erase command input device.

10. A control method for recording the number of persons that appear in a moving image, comprising the steps of:
detecting, for every specific frame, the number of persons contained in one frame of an image that constitutes a moving image represented by applied moving-image data; and
recording data, which represents the number of persons detected, on a recording medium in association with the specific frame and the moving-image data.

11. A still-image playback method comprising the steps of:
reading still-image data from a recording medium on which a plurality of frames of still-image data representing a still image have been recorded;
detecting the number of persons contained in a still image represented by still-image data that has been read;
determining whether to display the still image, which is represented by the still-image data that has been read, based upon the number of persons detected;
displaying on a display unit the still image determined is to be displayed; and
repeating processing for reading the still-image data, processing for detecting number of persons, determination processing and processing for controlling the display unit.
